(19) United States
(12) Patent Application Publication
(10) Pub. No.: US 2009/0166106 A1
(43) Pub. Date: Jul. 2, 2009

(54) Vehicles Having Tandem Axle Assembly

(76) Inventor: Scott Daniel Batdorf, Raymond, OH (US)

Correspondence Address: ULMER & BERNE, LLP;ATTN: DIANE BELL, 600 VINE STREET, SUITE 2800, CINCINNATI, OH, 45202, US

(21) Appl. No.: 11/965,181

(22) Filed: Dec. 27, 2007

(51) Int. Cl. B62D 61/10

(52) U.S. Cl. 180/24.06; 903/903

(57) ABSTRACT

A vehicle, such as a heavy truck, includes a tandem axle assembly supported with respect to a frame. The tandem axle assembly has first and second axle assemblies which each include respective left and right wheels. A third axle assembly is supported with respect to the frame and includes left and right wheels which are steerable by an operator to facilitate steering of the vehicle. The engine is coupled with the first axle assembly. A motor/generator is coupled with the second axle assembly. A controller is attached to each of the motor/generator and an energy storage device.

### TECHNICAL FIELD

A vehicle, such as a heavy truck, includes a tandem axle assembly including a first axle assembly coupled with an engine and a second axle assembly coupled with a motor/generator.

### BACKGROUND

Certain conventional vehicles include a hybrid-electric powertrain. In vehicles having a series hybrid-electric powertrain, an internal combustion engine is coupled with a generator. Power from the generator is fed to batteries and an electric motor. The electric motor is coupled with the vehicle's wheels to facilitate selective propulsion of the vehicle.

In vehicles having a parallel hybrid-electric powertrain, both an engine and an electric motor/generator are coupled with the vehicle's wheels to facilitate selective propulsion of the vehicle. At times, such as when maximum power is desired, the electric motor/generator is activated to assist the engine in powering the wheels. However, at certain other times (e.g., when braking), the electric motor/generator generates electricity for storage in batteries.

### SUMMARY

In accordance with one embodiment, a vehicle comprises a frame and a tandem axle assembly. The tandem axle assembly is supported with respect to the frame and comprises a first axle assembly and a second axle assembly. The first axle assembly comprises a first left wheel and a first right wheel. The second axle assembly comprises a second left wheel and a second right wheel. The vehicle also comprises a third axle assembly, an engine, a motor/generator, an energy storage device, and a controller. The third axle assembly is supported with respect to the frame and comprises a third left wheel and a third right wheel. Each of the third left wheel and the third right wheel are steerable by an operator to facilitate steering of the vehicle. The engine is coupled with the first axle assembly. The motor/generator is coupled with the second axle assembly and is free of any direct mechanical coupling with the first axle assembly. The controller is attached to each of the motor/generator and the energy storage device.

In accordance with another embodiment, a vehicle comprises a frame and a tandem axle assembly. The tandem axle assembly is supported with respect to the frame and comprises a first axle assembly and a second axle assembly. The first axle assembly comprises a first left wheel, a first right wheel, and a first differential. The first left wheel and the first right wheel are attached to opposite sides of the first differential. The second axle assembly comprises a second left wheel and a second right wheel. The vehicle also comprises a third axle assembly, an engine, a transmission, a drive shaft, an electric motor, a battery, and a controller. The third axle assembly is supported with respect to the frame and comprises a third left wheel and a third right wheel. Each of the third left wheel and the third right wheel are steerable by an operator to facilitate steering of the vehicle. The transmission is coupled with the engine. The drive shaft is coupled with each of the transmission and the first differential. The electric motor is coupled with the second axle assembly and is free of any direct mechanical coupling with the first axle assembly. The controller is attached to each of the electric motor and the battery.

In accordance with yet another embodiment, a vehicle comprises a frame and a tandem axle assembly. The tandem axle assembly is supported with respect to the frame and comprises a first axle assembly and a second axle assembly. The first axle assembly comprises a first left wheel and a first right wheel which are together configured to exert a first longitudinal force upon a roadway. The second axle assembly comprises a second left wheel and a second right wheel which are together configured to exert a second longitudinal force upon a roadway. The vehicle also comprises a third axle assembly, an engine, a motor/generator, an energy storage device, and a controller. The third axle assembly is supported with respect to the frame and comprises a third left wheel and a third right wheel. Each of the third left wheel and the third right wheel are steerable by an operator to facilitate steering of the vehicle. The engine is coupled with the first axle assembly. The motor/generator is coupled with the second axle assembly. The controller is attached to each of the motor/generator and the energy storage device and is configured to facilitate variation of the second longitudinal force with respect to the first longitudinal force.

### BRIEF DESCRIPTION OF THE DRAWINGS

It is believed that certain embodiments will be better understood from the following description taken in conjunction with the accompanying drawings in which:

FIG. 1 is a left side elevational view of a truck having a tandem axle assembly in accordance with one embodiment; and

FIG. 2 is top plan view depicting certain components of the truck of FIG. 1 wherein other components of the truck of FIG. 1 have been removed for clarity of illustration;

FIG. 3 is a top plan view depicting certain components of a truck in accordance with another embodiment;

FIG. 4 is a schematic view depicting an electric motor, a battery, and a controller such as might be provided upon the truck of FIGS. 1-2; and

FIG. 5 is a schematic view depicting electric motors, a battery, and a controller such as might be provided upon the truck of FIG. 3.

### DETAILED DESCRIPTION

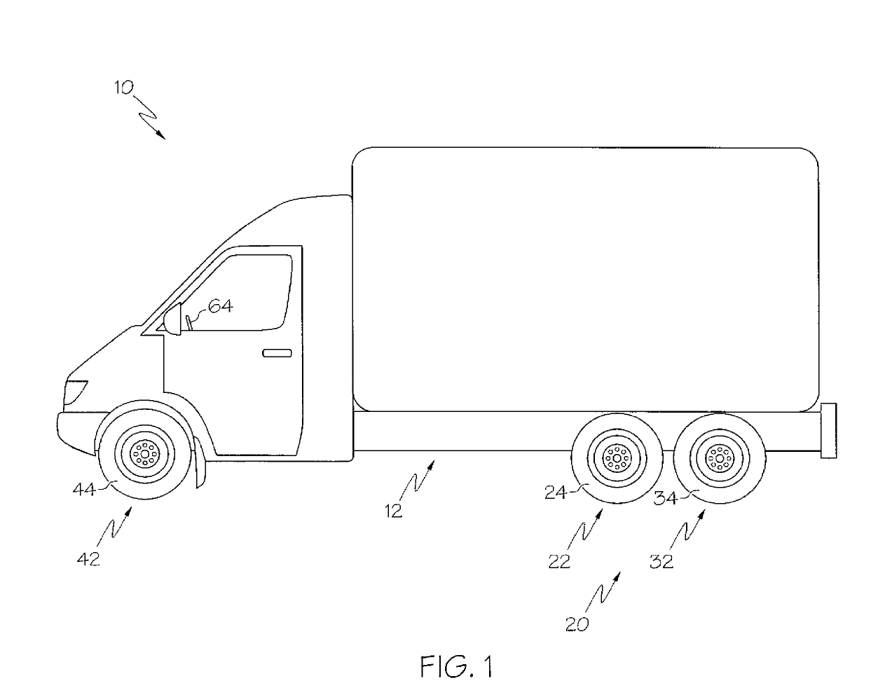

Embodiments are hereinafter described in detail in connection with the views and examples of FIGS. 1-5, wherein like numbers indicate the same or corresponding elements throughout the views. A tandem axle assembly can be provided upon any of a variety of vehicles such as, for example, a truck, an automobile, an all terrain vehicle (“ATV”), a light utility vehicle, a multi-use vehicle, a golf cart, a van, a recreational vehicle, a bus, an aircraft, agricultural equipment, and construction equipment. In one embodiment, a tandem axle assembly can be provided upon a heavy truck such as, for example, a box-type truck or a semi-tractor.

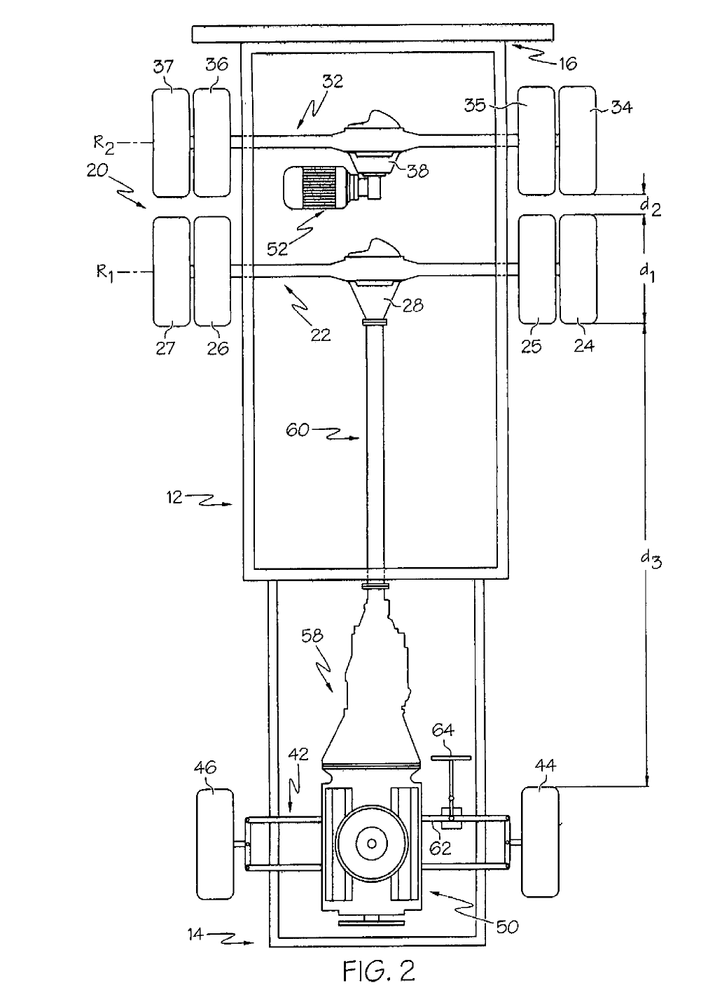

For example, a truck 10 is shown in FIG. 1 to comprise a box-type truck having a tandem axle assembly 20 supported with respect to a frame 12. It will be appreciated that a tandem axle assembly can be supported with respect to a frame through use of any of a variety of suspension components such as shocks, springs, cushions, linear electromagnetic motors, or the like. The tandem axle assembly 20 is shown to include a first axle assembly 22 and a second axle assembly 32. In alternative embodiments, it will be appreciated that a tandem axle assembly might include more than two respective axle assemblies. As shown in FIG. 2, the first axle assembly 22 comprises left wheels 24, 25 and right wheels 26, 27 which share a common first rotational axis R₁. Likewise, the second axle assembly 32 comprises left wheels 34, 35 and right wheels 36, 37 which share a common second rotational axis R₂. The first and second rotational axes R₁ and R₂ can be parallel with one another as shown in FIG. 2. In an alternative embodiment, an individual axle assembly of a tandem axle assembly might comprise only a single left wheel and a single right wheel. In yet another alternative embodiment, an individual axle assembly of a tandem axle assembly might comprise more than two left wheels and more than two right wheels. It will be appreciated that, in some embodiments, an individual axle assembly of a tandem axle assembly (e.g., a second axle assembly) might comprise an airlift axle which may be selectively mechanically raised with respect to a roadway so that wheels of the second axle assembly might be selectively raised from contact with the roadway.

The truck 10 is also shown to include a third axle assembly 42 which is supported with respect to the frame 12. The third axle assembly 42 can comprise a left wheel 44 and a right wheel 46. Steering linkage (e.g., 62) can couple a steering wheel 64 with the left wheel 44 and the right wheel 46 to facilitate steering of the left wheel 44 and the right wheel 46 by an operator, and resultant steering of the truck 10 by the operator. It will be appreciated that steering linkage can be provided in any of a variety of suitable configurations. The third axle assembly 42 is shown in FIG. 2 to be free of any axle extending between and connecting with each of the left and right wheels 44, 46. In an alternative embodiment, an axle might be provided along a common rotational axis of both left and right front wheels of a third axle assembly and can connect with each of those wheels. While the third axle assembly 42 is shown in FIG. 2 to be configured to facilitate steering of the truck 10 by an operator, it will be appreciated that one or more axle assemblies of a tandem axle assembly might also include wheels which are steerable by an operator to facilitate steering of a vehicle.

The frame 12 is shown in FIG. 2 to extend between a forward end 14 and a rearward end 16. The tandem axle assembly 20 is shown to be adjacent to the rearward end 16 of the frame 12. The third axle assembly 42 is shown to be adjacent to the forward end 14 of the frame 12. In the embodiment of FIG. 2, the second axle assembly 32 is shown to be provided more closely adjacent than the first axle assembly 22 to the rearward end 16 of the frame 12. However, it will be appreciated that respective axle assemblies call be located in any of a variety of other positions with respect to the frame of a vehicle.

In one embodiment, as shown in FIG. 2, the first and second axle assemblies 22, 32 can be supported with respect to the frame 12 such that the left wheels 24, 25 of the first axle assembly 22 are spaced from the left wheels 34, 35 of the second axle assembly 32 by a distance (e.g., d₂) of less than twice a diameter (e.g., d₁) of any of the left wheels 24, 25, 34, 35. In this same embodiment, the right wheels 26, 27 of the first axle assembly 22 can similarly be spaced from the right wheels 36, 37 of the second axle assembly 32 by a distance (e.g., d₂) of less than twice a diameter (e.g., d₁) of any of the right wheels 26, 27, 36, 37. In an alternative embodiment, first and second axle assemblies can be supported with respect to a vehicle's frame such that a left wheel of the first axle assembly is spaced from a left wheel of the second axle assembly by a distance of less than the diameter of either of those left wheels, and the right wheels of the first and second axle assemblies can be similarly spaced. In another alternative embodiment, first and second axle assemblies can be supported with respect to a vehicle's frame such that a left wheel of the first axle assembly is spaced from a left wheel of the second axle assembly by a distance of less than three times the diameter of either of those left wheels, and the right wheels of the first and second axle assemblies can be similarly spaced.

In one embodiment, as shown in FIG. 2, the first, second, and third axle assemblies 22, 32, 42 can be supported with respect to the frame 12 such that the left wheel 44 of the third axle assembly 42 is spaced from the left wheels 24, 25 and 34, 35 of the first and second axle assemblies 22, 32, respectively, by a distance (e.g., d₃) of greater than twice a diameter (e.g., d₁) of any of the left wheels 24, 25, 34, 35, 44. Likewise, the right wheel 46 of the third axle assembly 42 is shown to be spaced from the right wheels 26, 27 and 36, 37 of the first and second axle assemblies 22, 32, respectively, by a distance (e.g., d₃) of greater than twice a diameter (e.g., d₁) of any of the right wheels 26, 27, 36, 37, 46. However, it will be appreciated that a third axle assembly may be alternatively spaced with respect to a tandem axle assembly.

The truck 10 is also shown in FIG. 2 to include an engine 50, a transmission 58, and a drive shaft 60 which are each supported with respect to the frame 12. The engine 50 can comprise an internal combustion engine which is configured to consume gasoline, diesel fuel, propane, ethanol, hydrogen, and/or any of a variety of other fuels. The first axle assembly 22 can comprise a differential 28, and the left wheels 24, 25 and the right wheels 26, 27 can be attached to opposite sides of the differential 28 as shown in FIG. 2. The transmission 58 is shown to be coupled with the engine 50, and the drive shaft 60 is shown to couple the transmission 58 with the differential 28. It will be appreciated that the transmission 58 can comprise an automatic transmission, a manual transmission or gearbox, and/or any of a variety of other suitable devices or arrangements. It will also be appreciated that an engine may be coupled with a differential and/or another portion of a first axle assembly without the presence of a transmission and/or a driveshaft. In the arrangement of FIGS. 1-2, it can be seen that the left wheels 24, 25 and the right wheels 26, 27, under power from the engine 50, can together be configured to exert a longitudinal force upon a roadway to facilitate forward or rearward movement of the truck 10.

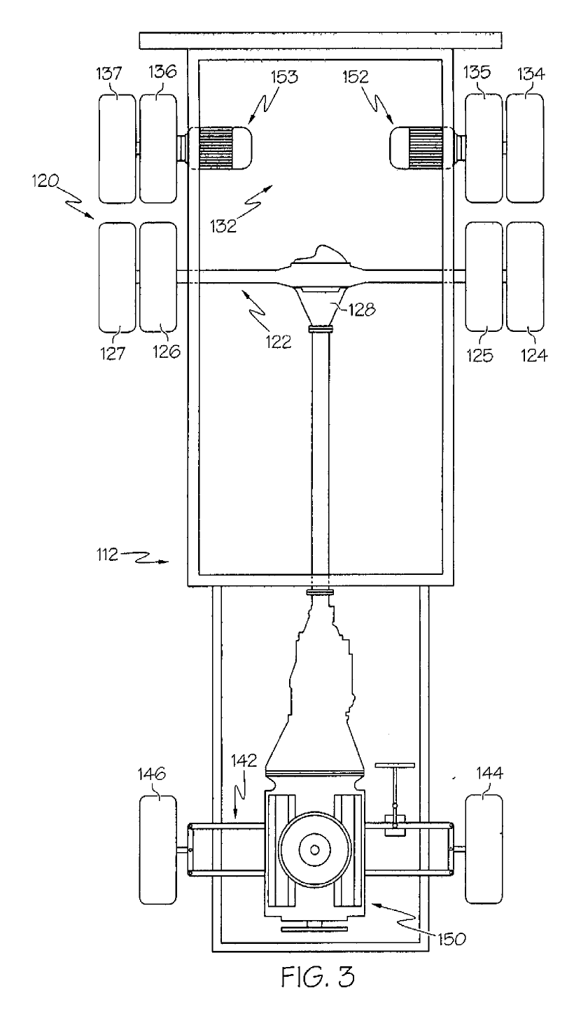

The second axle assembly 32 can comprise a differential 38, and the left wheels 34, 35 and the right wheels 36, 37 can be attached to opposite sides of the differential 38 as shown in FIG. 2. A motor/generator is shown to comprise an electric motor 52 which is coupled with the differential 38. The electric motor 52 can comprise any of a variety of types of motors such as, for example, a three-phase brushless variety. It will be appreciated that the electric motor 52 can, at times, receive power from an energy storage device, as described below, for causing the left wheels 34, 35 and the right wheels 36, 37 to rotate. It will also be appreciated that the electric motor 52 can, at other times, be rotated as a result of rotation of the left wheels 34, 35 and the right wheels 36, 37, and can accordingly generate electricity for passage to an energy storage device, as described below. While the motor/generator is shown to comprise the electric motor 52, it will be appreciated a motor/generator can alternatively comprise multiple electric motors (e.g., as described below with reference to FIG. 3) and/or any of a variety of other suitable arrangements including, for example, one or more flywheels, resilient members, and/or hydraulic or pneumatic motors.

In the arrangement of FIGS. 1-2, it can be seen that the left wheels 34, 35 and the right wheels 36, 37 can together be configured to exert a longitudinal force upon a roadway. In particular, when electric power is provided from an energy storage device to the electric motor 52, longitudinal force provided upon a roadway by the left wheels 34, 35 and the right wheels 36, 37 can facilitate forward or rearward movement of the truck 10. However, when electric power is withdrawn from the electric motor 52 for passage to all energy storage device, longitudinal force provided upon a roadway by the left wheels 34, 35 and the right wheels 36, 37 can facilitate slowing or braking of the truck 10.

In another embodiment, as shown in FIG. 3, a vehicle such as a truck can include a tandem axle assembly 120 which is supported with respect to a frame 112 and which includes a first axle assembly 122 and a second axle assembly 132. The first axle assembly 122 is shown to comprise left wheels 124, 125 and right wheels 126, 127, and the second axle assembly 132 is shown to comprise left wheels 134, 135 and right wheels 136, 137. A third axle assembly 142 is shown to be supported with respect to the frame 112 and to comprise a left wheel 144 and a right wheel 146 which might be steerable by an operator to facilitate steering of the vehicle. The first axle assembly 122 can comprise a differential 128 which is coupled with the engine 150, such as via a transmission and/or drive shaft, and such as described above with respect to FIG. 2. However, unlike with respect to FIG. 2 above, a motor/generator is shown to comprise a left motor/generator portion in the form of an electric motor 152, and a right motor/generator portion in the form of an electric motor 153. The electric motor 152 is shown to be coupled with the left wheels 134, 135, while the right electric motor 153 is shown to be coupled with the right wheels 136, 137. In this embodiment, it will be appreciated that propulsion and braking of the respective left and right wheels 134, 135 and 136, 137 can be achieved through separate control off the electric motors 152 and 153. It can also be seen in this embodiment that the second axle assembly 132 is free of any axle extending between and connecting with each of the left wheels 134, 135 and the right wheels 136, 137.

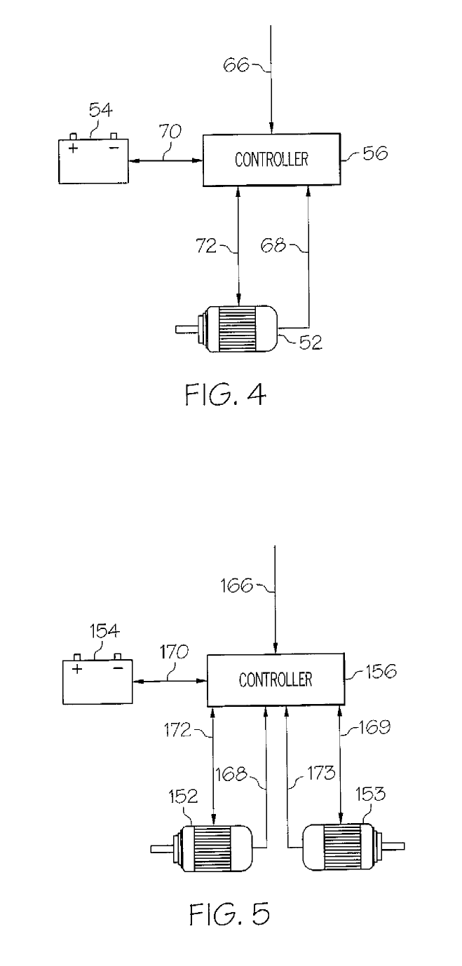

A vehicle in accordance with one embodiment can also include a controller and an energy storage device which are each associated with the motor/generator(s). For example, FIG. 4 depicts a controller 56 which might be provided for use upon the truck 10 of FIGS. 1-2. The controller 56 is shown to be attached to each of the electric motor 52 and a battery 54. While the energy storage device is shown in FIG. 4 to comprise a battery 54, it will be appreciated that a controller might additionally or alternatively be attached to an energy storage device which includes multiple batteries connected in series and/or parallel, capacitors (e.g., ultracapacitors), and/or some other devices or arrangements for chemically and/or mechanically storing energy.

In the example of FIG. 4, the controller 56 is shown to selectively send and receive power to and from the battery 54 and the electric motor 52 through respective electrical conductors (e.g., wires) 70 and 72. The controller 56 can also receive control and/or feedback signals. For example, the controller 56 can receive (e.g., via an electrical conductor 68, and/or wirelessly) feedback signals from an encoder or other speed and/or position monitoring sensor associated with the electric motor 52 which, it will be appreciated, can reflect the rotational speed of the wheels 34, 35, 36, 37 of the second axle assembly 32. The controller 56 can also receive (e.g., via an electrical conductor 66, and/or wirelessly) control and/or feedback signals which indicate the rotational speed of other wheels (e.g., 24, 25, 26, 27, 44, 46) present upon the truck, engine speed, activation of brake lights, charge level of an energy storage device, and/or displacement of accelerator and/or brake pedals, for example. It will be appreciated that the controller 56 might receive any of a variety of alternative or additional types of control and/or feedback signals. For example, the controller 56 might receive signals from a switch or other actuator which an operator might use to selectively enable, disable, and/or adjust operation or performance of the electric motor 52. A controller can comprise control circuitry (e.g., including one or more microprocessors) and power switching components (e.g., including transistors or the like) for facilitating power transfer between a motor/generator and an energy storage device in response to control and/or feedback signals received by the controller.

As described above with reference to FIGS. 2 and 4, it can be seen that FIG. 5 depicts a controller 156 which might be provided for use upon the vehicle of FIG. 3. The controller 156 is shown to be attached to a battery 154 and the electric motors 152 and 153. The controller 156 is shown to be connected for sending power to and for receiving power from the battery 154 and the electric motors 152 and 153 through respective electrical conductors (e.g., wires) 170, 172, and 173. Each of the electric motors 152, 153 can provide speed and/or position feedback signals to the controller 156 (e.g., via respective electrical conductors 168, 169, and/or wirelessly). As described above with respect to the controller 56, the controller 156 can also receive (e.g., via an electrical conductor 166, and/or wirelessly) control and/or feedback signals.

It can be seen in FIG. 2 that, while the electric motor 52 is coupled with the second axle assembly 32, the electric motor 52 and the second axle assembly 32 are free of any direct mechanical coupling with the first axle assembly 22 and/or the engine 50. In this configuration, the only mechanical coupling between the engine 50 and the electric motor 52, and thus between the first and second axle assemblies 22, 32, is through the roadway. Likewise, it can be seen in FIG. 3 that, while the electric motors 152, 153 are coupled with respective left and right wheels 134, 135 and 136, 137 of the second axle assembly 132, the electric motors 152, 153 and the second axle assembly 132 are free of any direct mechanical coupling with the first axle assembly 122 and/or the engine 150. In this configuration, the only mechanical coupling between the engine 150 and the electric motors 152, 153, and thus between the first and second axle assemblies 122, 132, is through the roadway. As such, it will be appreciated that longitudinal force provided upon a roadway by the second axle assembly 32, 132 (arising from torque developed by the electric motors 52, or 152, 153) can be controlled independently of any longitudinal force provided upon the roadway by the first axle assembly 22, 122 (arising from torque developed by the engine 50 or 150). Accordingly, the controller 56, 156 call be configured to facilitate variation of the longitudinal force provided upon a roadway by wheels of the second axle assembly 32, 132 with respect to the longitudinal force provided upon the roadway by wheels of the first axle assembly 22, 122.

By monitoring the rotational speed of motor/generator(s) associated with a second axle assembly, a controller can determine rotational speed of left and right wheels of the second axle assembly. The controller can also receive speed signals from a wheel speed sensor, an engine speed sensor, and/or some other device which indicates the speed of wheels of a first axle assembly. Through monitoring of speed of wheels of the first axle assembly, and by regulating the amount of torque provided by the motor/generator(s), the controller can control the amount of longitudinal force provided upon a roadway by the wheels of the second axle assembly such that these wheels do not slip with respect to the roadway (either when driving or braking the vehicle). In this manner, the controller can effectively prevent wheel skid which might otherwise arise from an excessive difference in rotational torque of wheels of the first and second axle assemblies.

It will be appreciated that a second axle assembly, motor/generator, controller, and energy storage device can be easily installed upon an otherwise conventional vehicle. For example, a second axle assembly can be installed upon a conventional truck just as would a conventional removable axle assembly when increasing the cargo-carrying capability of the truck. The second axle assembly can be provided in place of a conventional dead or lazy axle located immediately behind a drive axle (in which case the dead axle is often called a tag axle) or immediately in front of a drive axle (in which case the dead axle is often called a pusher axle). Also, though FIGS. 1-3 depict vehicles having a tandem axle assembly comprising two respective axle assemblies, it will be appreciated that a vehicle can include a tandem axle assembly having more than two respective axle assemblies (e.g., three, four, five, or six respective axle assemblies), and that one or more of those axle assemblies can interface motor/generators (e.g., as does the above-described second axle assembly 32) and can be positioned between, ahead of, and/or behind other axle assemblies which are configured as dead axles and/or drive axles.

In one embodiment, such as when the motor/generator comprises an electric motor, the motor/generator and the controller can be attached to the second axle assembly so that these components call be attached to the truck in a single step. The energy storage device might comprise one or more batteries which are attached to the second axle assembly or are provided elsewhere upon the truck. By then wiring the controller to the battery or batteries, and then installing control wiring and/or one or more sensors (e.g., wheels speed sensors for engine-driven wheels of a first axle assembly), it will be appreciated that a conventional truck can be converted into a hybrid vehicle without requiring any mechanical connection to the drivetrain or engine of the truck, and therefore without requiring significant labor, time, or cost expenditure. Of course, these components can be removed from the truck when desired and then reinstalled upon mother vehicle. In this manner, a modular system is provided to facilitate selective conversion of a conventional vehicle to a hybrid vehicle. In another embodiment, these components can be installed as a permanent feature of a vehicle by the manufacturer of the vehicle or through an aftermarket retrofit process.

In use of the truck 10, when increased torque is required (e.g., during rapid acceleration), it will be appreciated that the controller 56 can facilitate passage of electric power from the battery 54 to the electric motor 52. The electric motor 52 can resultantly cause the left and right wheels 34, 35 and 36, 37 of the second axle assembly 32 to apply longitudinal force upon a roadway to assist the engine 50 in propelling the truck 10. However, at other times (e.g., when braking or traveling downhill, and/or when the battery 54 requires charging), it will be appreciated that the controller 56 can facilitate passage of electric power from the electric motor 52 to the battery 54. At such other times, the electric motor 52 can impose rotational resistance upon the left and right wheels 34, 35 and 36, 37 of the second axle assembly 32 such that longitudinal force is applied upon a roadway by the second axle assembly 32 to facilitate braking of the truck 10. The electric power remains in the battery 54 until such time as the electric motor 52 is required to again propel the truck 10. It will be appreciated that this hybrid drive arrangement can facilitate improved fuel efficiency, improved acceleration, improved braking, improved traction, and increased longevity of wheels and braking system components, among other advantages.

The foregoing description of embodiments and examples has been presented for purposes of illustration and description. It is not intended to be exhaustive or to limit the invention to the forms described. Numerous modifications are possible in light of the above teachings. Some of those modifications have been discussed and others will be understood by those skilled in the art. The embodiments were chosen and described in order to best illustrate certain principles and various embodiments as are suited to the particular use contemplated. The scope of the invention is, of course, not limited to the examples or embodiments set forth herein, but can be employed in any number of applications and equivalent devices by those of ordinary skill in the art. Rather it is hereby intended the scope of the invention be defined by the claims appended hereto.

What is claimed is:

1. A vehicle comprising:
a frame;
a tandem axle assembly supported with respect to the frame and comprising a first axle assembly and a second axle assembly, the first axle assembly comprising a first left wheel and a first right wheel, the second axle assembly comprising a second left wheel and a second right wheel;
a third axle assembly supported with respect to the frame and comprising a third left wheel and a third right wheel, each of the third left wheel and the third right wheel being steerable by an operator to facilitate steering of the vehicle;
an engine coupled with the first axle assembly;
a motor/generator coupled with the second axle assembly, and free of any direct mechanical coupling with the first axle assembly;
an energy storage device; and
a controller attached to each of the motor/generator and the energy storage device.

2. The vehicle of claim 1 further comprising a transmission and a drive shaft, wherein the transmission is coupled with the engine, the first axle assembly comprises a first differential, the first left wheel and the first right wheel are attached to opposite sides of the first differential, and the drive shaft couples the transmission with the first differential.

3. The vehicle of claim 2 wherein the second axle assembly comprises a second differential, the second left wheel and the second right wheel are attached to opposite sides of the second differential, and the motor/generator is coupled with the second differential.

4. The vehicle of claim 2 wherein the motor/generator comprises a left motor/generator portion and a right motor/generator portion, the left motor/generator portion is coupled with the second left wheel, and the right motor/generator portion is coupled with the second right wheel.

5. The vehicle of claim 4 wherein the second axle assembly is free of any axle extending between and connecting with each of the second left wheel and the second right wheel.

6. The vehicle of claim 1 wherein the first left wheel is spaced from the second left wheel by a distance of less than twice a diameter of the first left wheel, and the first right wheel is spaced from the second right wheel by a distance of less than twice a diameter of the first right wheel.

7. The vehicle of claim 1 wherein the frame extends between a forward end and a rearward end, the tandem axle assembly is adjacent to the rearward end of the frame, and the third axle assembly is adjacent to the forward end of the frame.

8. The vehicle of claim 7 wherein the second axle assembly is more closely adjacent than the first axle assembly to the rearward end of the frame.

9. The vehicle of claim 1 wherein the third left wheel is spaced from each of the first left wheel and the second left wheel by a distance of greater than twice a diameter of the first left wheel, and the third right wheel is spaced from each of the first right wheel and the second right wheel by a distance of greater than twice a diameter of the first right wheel.

10. The vehicle of claim 1 wherein each of the first left wheel, the first right wheel, the second left wheel, and the second right wheel comprises a respective pair of wheels.

11. The vehicle of claim 1 wherein the energy storage device comprises a battery and wherein the motor/generator comprises an electric motor.

12. The vehicle of claim 1 wherein the third axle assembly is free of any axle extending between and connecting with each of the third left wheel and the third right wheel.

13. A vehicle comprising:
a frame;
a tandem axle assembly supported with respect to the frame and comprising a first axle assembly and a second axle assembly, the first axle assembly comprising a first left wheel, a first right wheel, and a first differential, the first left wheel and the first right wheel being attached to opposite sides of the first differential, and the second axle assembly comprising a second left wheel and a second right wheel;
a third axle assembly supported with respect to the frame and comprising a third left wheel and a third right wheel, each of the third left wheel and the third right wheel being steerable by an operator to facilitate steering of the vehicle;
an engine;
a transmission coupled with the engine;
a drive shaft coupled with each of the transmission and the first differential;
a electric motor coupled with the second axle assembly and free of any direct mechanical coupling with the first axle assembly;
a battery; and
a controller attached to each of the electric motor and the battery.

14. The vehicle of claim 13 wherein the second axle assembly comprises a second differential, the second left wheel and the second right wheel are attached to opposite sides of the second differential, and the electric motor is coupled with the second differential.

15. A vehicle comprising:
a frame;
a tandem axle assembly supported with respect to the frame and comprising a first axle assembly and a second axle assembly, the first axle assembly comprising a first left wheel and a first right wheel which are together configured to exert a first longitudinal force upon a roadway, the second axle assembly comprising a second left wheel and a second right wheel which are together configured to exert a second longitudinal force upon a roadway;
a third axle assembly supported with respect to the frame and comprising a third left wheel and a third right wheel, each of the third left wheel and the third right wheel being steerable by an operator to facilitate steering of the vehicle;
an engine coupled with the first axle assembly;
a motor/generator coupled with the second axle assembly;
an energy storage device; and
a controller attached to each of the motor/generator and the energy storage device, wherein the controller is configured to facilitate variation of the second longitudinal force with respect to the first longitudinal force.

16. The vehicle of claim 15 further comprising a transmission and a drive shaft, wherein the transmission is coupled with the engine, the first axle assembly comprises a first differential, the first left wheel and the first right wheel are attached to opposite sides of the first differential, and the drive shaft couples the transmission with the first differential.

17. The vehicle of claim 16 wherein the second axle assembly comprises a second differential, the second left wheel and the second right wheel are attached to opposite sides of the second differential, and the motor/generator is coupled with the second differential.

18. The vehicle of claim 16 wherein the motor/generator comprises a left motor/generator portion and a right motor/generator portion, the left motor/generator portion is coupled with the second left wheel, and the right motor/generator portion is coupled with the second right wheel.

19. The vehicle of claim 15 wherein the first left wheel is spaced from the second left wheel by a distance of less than twice a diameter of the first left wheel, the first right wheel is spaced from the second right wheel by a distance of less than twice a diameter of the first right wheel, the third left wheel is spaced from each of the first left wheel and the second left wheel by a distance of greater than twice a diameter of the first left wheel, and the third right wheel is spaced from each of the first right wheel and the second right wheel by a distance of greater than twice a diameter of the first right wheel.

20. The vehicle of claim 15 wherein the energy storage device comprises a battery and wherein the motor/generator comprises an electric motor.
